(19) United States
(12) Patent Application Publication
(10) Pub. No.: US 2008/0092071 A1
(43) Pub. Date: Apr. 17, 2008

(54) AUTOMATICALLY COLLAPSING ADVERTISING MODULE

(76) Inventor: Fu-Sheng CHIU, Taipei City (TW)

Correspondence Address: SINORICA, LLC, 528 FALLSGROVE DRIVE, ROCKVILLE, MD, 20850, US

(21) Appl. No.: 11/555,664

(22) Filed: Nov. 1, 2006

(30) Foreign Application Priority Data
Oct. 14, 2006 (TW) 095137788

(51) Int. Cl. G06F 3/048; G07G 1/14; G06F 17/00

(52) U.S. Cl. 715/764; 705/14; 715/255; 715/272

(57) ABSTRACT

A method of Internet advertising comprising an advertising module that automatically closes or collapses after a short period of time is disclosed. The advertisement section of the advertising module comprises flash animation or static text and graphics. While a webpage is loading the advertising module is displayed in the user's browser window. When the webpage is fully loaded or after a pre-set period of time the advertising module automatically collapses or disappears. After the advertising module collapses a small icon is displayed so that users can re-open the advertisement by clicking on the icon. When a user clicks on the icon the advertising module expands to the original advertisement. The content displayed in the advertising module is an advertisement, a plurality of advertisements, or a mini website with navigation controls.

### BACKGROUND OF THE INVENTION

1. Field of the Invention

The present invention relates to advertising. More specifically, the present invention discloses a method for Internet advertising that comprises an automatically collapsing advertising section of a webpage that is displayed while the webpage is loading and disappears after a brief period of time.

2. Description of the Prior Art

Traditional methods of advertising on the Internet include banner ads and pop-up advertisements. Banner ads are positioned at the top of a web page and reappear on the top of every page that a user visits. Since the advertisement shows up on every page users are irritated by repeatedly seeing the advertisement.

Additionally, the screen real estate required to hold the banner advertisement is wasted as the most valuable screen area is the top of the web page. This area could be used for positioning the most valuable website content rather than advertising.

Furthermore, in order to view real content on the website users are required to scroll down the page. This also frustrates users that are seeking good content.

Pop-up advertisements are advertisements that pop up in a new window in front of the original web page. Users must manually close the pop-up advertisement window in order to view the website content. This is extremely irritating to users especially when users navigate through several pages of the website. As a result users tend to avoid websites that implement pop-up advertising.

Additionally, some web browsers such as Mozilla Firefox or Microsoft Internet Explorer have options or plug-ins that prevent pop-up windows. This makes pop-up advertising useless as users do not even see the advertisement.

The conventional methods of displaying advertising on the Internet irritate and frustrate users. This is not beneficial for website sponsors or advertisers. If users are angered by advertisements they will turn this anger towards the advertiser and will boycott the advertiser's goods and potentially spread ill will against the advertiser and the advertiser's product. As a result, advertiser's waste money and lose revenue from lost sales.

Therefore there is need for a method of advertising on the internet that is not intrusive, irritating, or frustrating to users and at the same time highly effective for advertisers thereby increasing advertiser's revenue.

### SUMMARY OF THE INVENTION

To achieve these and other advantages and in order to overcome the disadvantages of the conventional method in accordance with the purpose of the invention as embodied and broadly described herein, the present invention provides a method of Internet advertising that is effective for advertisers and at the same time unobtrusive to users.

The method of the present invention comprises an advertising module that automatically closes or collapses after a short period of time. The advertisement section of the advertising module comprises flash animation or static text and graphics. While a webpage is loading the advertising module is displayed in the user's browser window. When the webpage is loaded the advertising module collapses or disappears.

In an embodiment of the present invention the advertisement is displayed until the webpage is fully loaded before disappearing. In another embodiment of the present invention the advertisement is displayed for a pre-set period of time, for example 2 or 3 seconds.

Since the advertisement is shown for only a short period of time users are not irritated. Also, since the advertisement collapses and disappears, valuable screen real estate is not wasted. After the advertisement collapses the webpage is displayed as originally intended by the website designer.

Normally users must wait several seconds as a webpage loads and appears. This time is typically wasted as users sit idle waiting. An advantage of the present invention is that during the webpage loading time an advertisement is displayed and when the page is loaded the advertisement disappears. This is beneficial to advertisers who can utilize this previously wasted time.

After the advertising module collapses a small icon is displayed so that users can re-open the advertisement by clicking on the icon. When a user clicks on the icon the advertising module expands to the original advertisement. In this way, users can look at advertisements that they are interested in viewing and users who aren't interested in the particular advertisement are not irritated.

In an embodiment of the present invention when a user clicks on the icon to re-open the advertisement the action is recorded. The number or percentage of users who re-open the advertising module is collected and provided to marketing personnel for reference or for collection of revenue. In this embodiment, website operators are compensated for the number of users who re-open the advertisement.

In another embodiment of the present invention, the advertising module comprises a mini website. In this embodiment, when a user expands the advertising module a website with navigation menu is displayed in the same size as the advertising module. While the advertising module is relatively small as compared to the webpage, the mini website is effective for providing succinct information. In essence this embodiment comprises a website within a webpage. Since the user does not navigate away from the original website but navigates within a webpage, website operators can keep their users. With the conventional method users navigate away from the original website when they click on an advertisement. However, with the method of the present invention users stay within the original website when viewing advertisements, offsite webpages, or other websites.

In this embodiment the mini website comprises a navigation menu similar to a typical website. Users can visit another mini webpage of the mini website by clicking on the desired menu options. Due to the small size of the advertising module window information can be presented in a very direct and effective manner.

In an embodiment of the present invention the advertisement displayed in the advertising module is targeted to a specific audience. For example, if a user clicks on a hyperlink to a webpage containing information about a singing star, the advertisement shown is regarding the star's music, concerts, or CDs for purchase. This allows advertisers to effectively target those users who would most likely be interested in seeing the advertisement. In this way, advertisers do not pay for ineffective advertisements that are shown to the masses.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing illustrating a homepage for a website utilizing an advertising module according to an embodiment of the present invention;

FIG. 2 is a drawing illustrating a webpage utilizing an advertising module according to an embodiment of the present invention;

FIG. 3 is a drawing illustrating a webpage with collapsed advertising module according to an embodiment of the present invention;

FIGS. 4 and 5 are drawings illustrating a webpage with an advertising module according to an embodiment of the present invention; and

FIG. 6 is a drawing illustrating a webpage with mini website according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

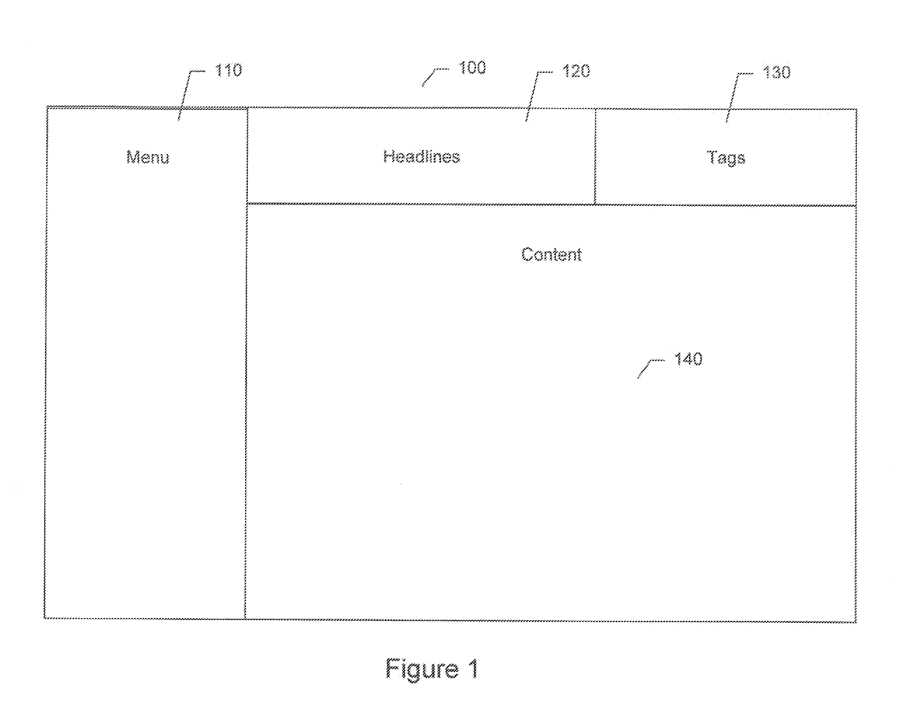

Refer to FIG. 1, which is a drawing illustrating a homepage for a website utilizing an advertising module according to an embodiment of the present invention.

As shown in FIG. 1, the homepage 100 comprises a navigation menu 110, a headlines section 120, a meta tags section 130, and a content links section 140. The navigation menu 110 is for providing options or links to various webpages of the website. The headlines section 120 is for displaying important information. The meta tags section 130 displays links to various content or showing commonly searched terms. The content links section 140 displays links to additional website content.

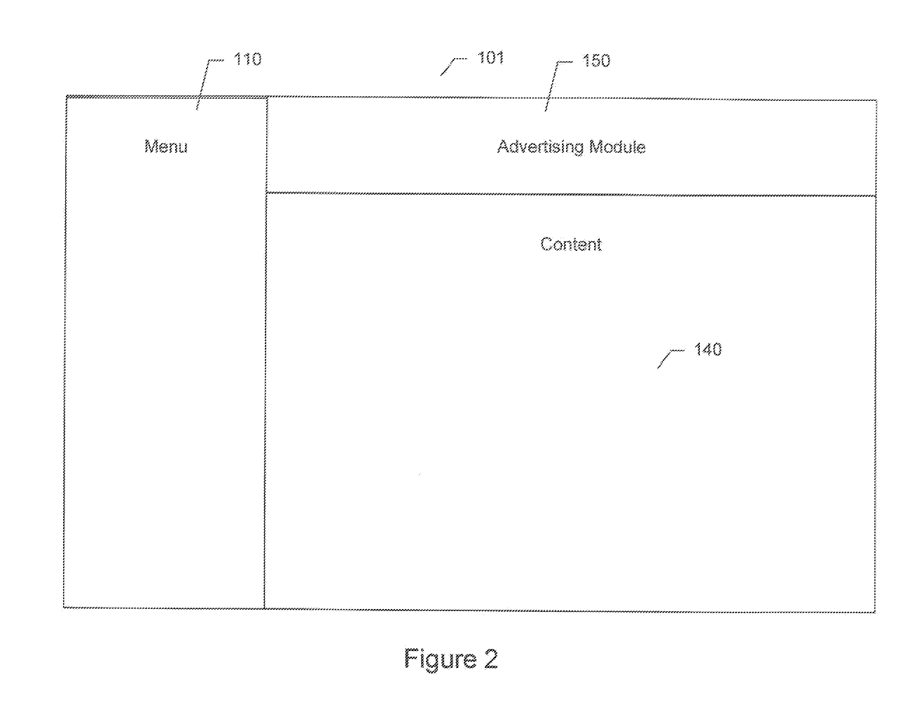

Refer to FIG. 2, which is a drawing illustrating a webpage utilizing an advertising module according to an embodiment of the present invention.

When a user clicks on a hyperlink in a webpage a new webpage 101 is displayed. The new webpage 101 comprises the menu 110, content links 140, and an advertising module 150. In this embodiment the advertising module is a relatively small area of the screen.

The advertising module 150 is displayed for a brief moment while the webpage 101 is loading. In an embodiment of the present invention the advertising module 150 is displayed as the webpage 101 is loading. In another embodiment of the present invention the advertising module 150 is displayed for a pre-set period of time, for example 2 or 3 seconds.

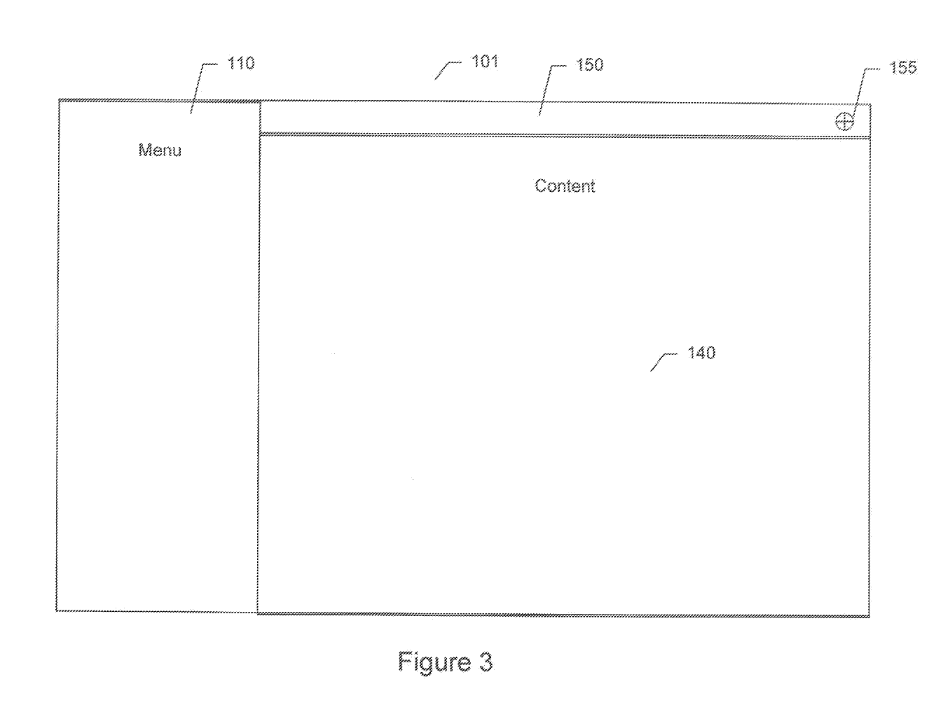

Refer to FIG. 3, which is a drawing illustrating a webpage with collapsed advertising module according to an embodiment of the present invention.

After the advertisement has been displayed, the advertising module 150 collapses and disappears. An icon 155 is displayed in order to allow users to re-open the advertising module 150. If a user clicks on the icon 155 the advertising module 150 expands to the original size. As a result, users that are interested in the advertisement can view it again. Users who aren't interested are not irritated by the advertisement since it isn't visible anymore. When the user is finished viewing the advertisement the user clicks the icon to collapse the advertising module.

In an embodiment of the present invention the advertisement in the advertising module is displayed only once. After the first viewing of the advertisement when a webpage containing the same advertisement is loaded the advertisement is not displayed. This further enhances the user's experience since they don't repeatedly view the same advertisement.

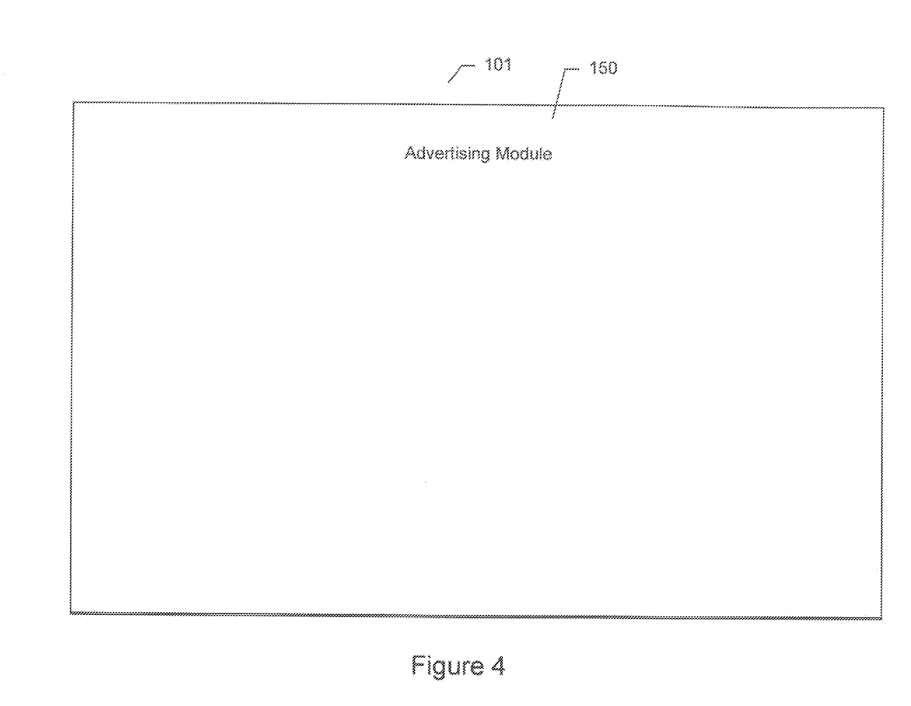

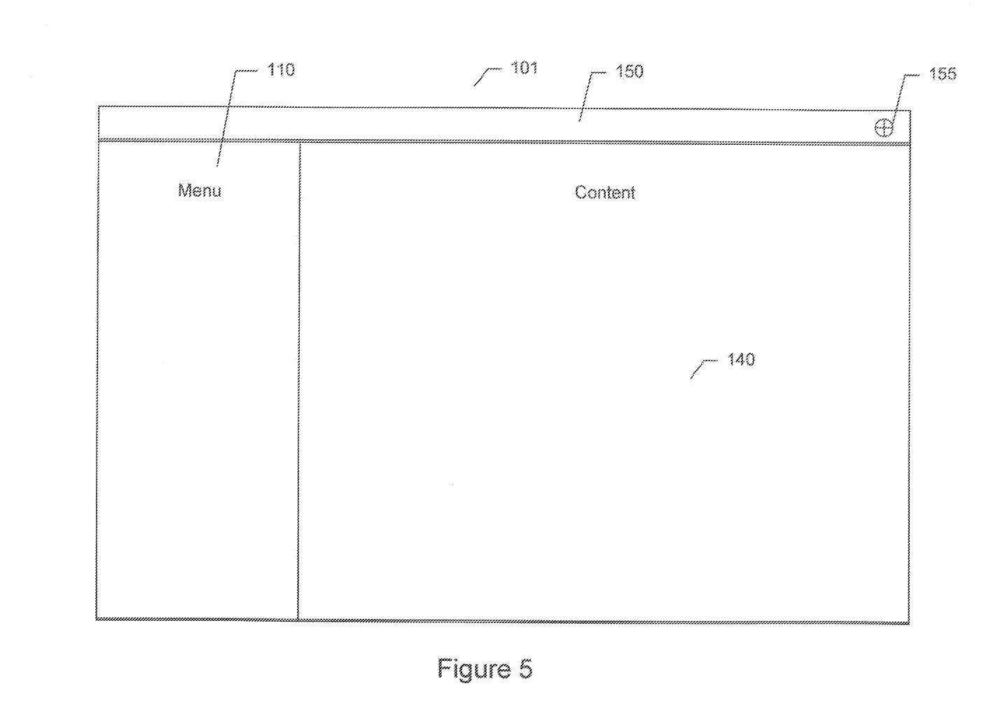

Refer to FIG. 4 and FIG. 5, which are drawings illustrating a webpage with an advertising module according to an embodiment of the present invention.

In this embodiment the advertising module 150 is full screen in size. While the webpage 101 is loading the full screen advertisement is displayed in the advertising module 150. When the webpage 101 is fully loaded or after a pre-set period of time, the advertising module 150 automatically collapses. An icon 155 is displayed in order to allow users to re-open the advertising module 150.

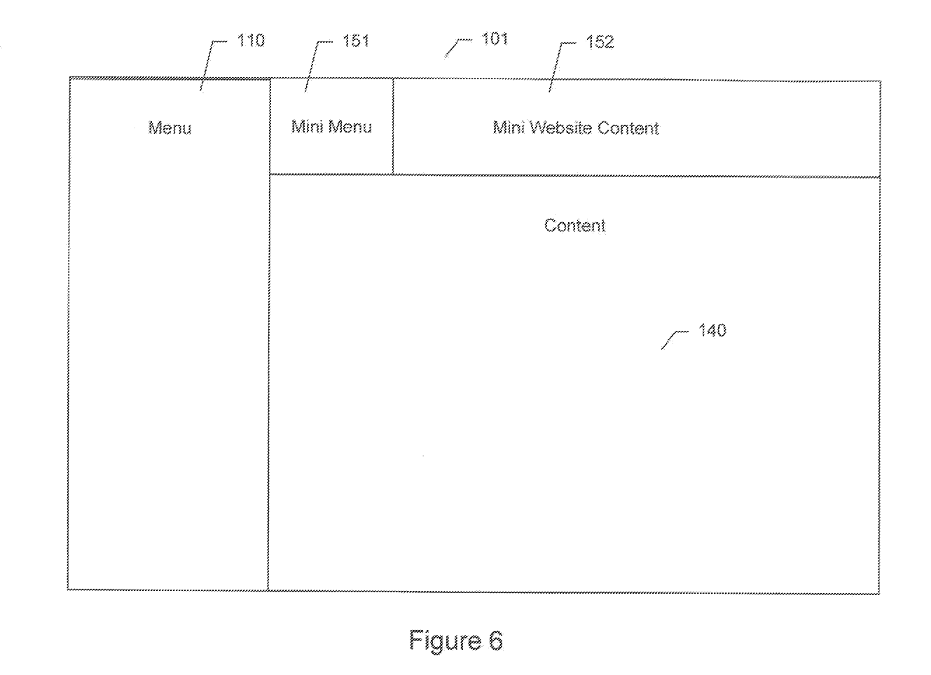

Refer to FIG. 6, which is a drawing illustrating a webpage with mini website according to an embodiment of the present invention.

In an embodiment of the present invention the advertising module 150 comprises a mini website. The mini website comprises a mini navigation menu 151 and mini website content 152. Users can navigate through the mini website by clicking on various options in the mini navigation menu 151.

In this embodiment users can view content from other content providers or website operators without leaving the original website. This allows website operators to keep users at their website rather than navigating away from the original website.

In another embodiment of the present invention the advertising module utilizes targeted advertising. When a user clicks on a particular hyperlink the advertising displayed is appropriate or coordinated with the hyperlinked content.

In another embodiment of the present invention a webpage comprises multiple advertising modules. Each module is displayed while the page is loading or for a pre-set period of time before the modules automatically collapse.

In an embodiment of the present invention the advertising module comprises a search engine for locating specific advertisements or content displayed in the advertising module. This allows users to find advertisements or content that they had previously viewed and wish to view again.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for Internet advertising comprising:
displaying an automatically collapsing advertising module in a webpage.

2. The method for Internet advertising of claim 1, where the advertising module collapses when the webpage is fully loaded.

3. The method for Internet advertising of claim 1, where the advertising module collapses after a pre-set period of time.

4. The method for Internet advertising of claim 1, where the advertising module collapses in less than three seconds.

5. The method for Internet advertising of claim 1, further comprising:
displaying an icon to allow a user to re-open the advertising module.

6. The method for Internet advertising of claim 1, where an advertisement is displayed in the advertising module.

7. The method for Internet advertising of claim 6, where the advertisement is displayed only once.

8. The method for Internet advertising of claim 5, where percentage or number of users who re-open the advertising module is recorded.

9. The method for Internet advertising of claim 6, where the advertisement is related to content in the webpage.

10. The method for Internet advertising of claim 1, where the advertising module comprises a mini website.

11. A method for Internet advertising comprising:
displaying an advertising module in a webpage while the webpage is loading; and
automatically collapsing the advertising module.

12. The method for Internet advertising of claim 11, where the advertising module collapses when the webpage is fully loaded.

13. The method for Internet advertising of claim 11, where the advertising module collapses after a pre-set period of time.

14. The method for Internet advertising of claim 11, where the advertising module collapses in less than three seconds.

15. The method for Internet advertising of claim 11, further comprising:
displaying an icon to allow a user to re-open the advertising module.

16. The method for Internet advertising of claim 11, where an advertisement is displayed in the advertising module.

17. The method for Internet advertising of claim 16, where the advertisement is displayed only once.

18. The method for Internet advertising of claim 15, where percentage or number of users who re-open the advertising module is recorded.

19. The method for Internet advertising of claim 16, where the advertisement is related to content in the webpage.

20. A method for Internet advertising comprising:
displaying an advertising module in a webpage while the webpage is loading;
automatically collapsing the advertising module; and
displaying an icon to allow a user to re-open the advertising module.
